(19) United States
(12) Patent Application Publication
(10) Pub. No.: US 2017/0090461 A1
(43) Pub. Date: Mar. 30, 2017

(54) CALIBRATION MARKER FOR 3D PRINTER CALIBRATION

(71) Applicant: CANON KABUSHIKI KAISHA, Tokyo (JP)

(72) Inventors: ERIC WAI-SHING CHONG, Carlingford (AU); PETER ALLEINE FLETCHER, Rozelle (AU); ROGER DAVID BUTLER, Abbotsford (AU)

(21) Appl. No.: 15/277,881

(22) Filed: Sep. 27, 2016

(30) Foreign Application Priority Data
Sep. 30, 2015 (AU) 2015234328

(51) Int. Cl. G05B 19/4099; B29C 67/00; G06F 17/14; B33Y 50/00

(52) U.S. Cl. CPC G05B 19/4099; B33Y 50/00; B29C 67/0088; G06F 17/14; G05B 2219/35134; G05B 2219/49007

(57) ABSTRACT

Method, system and calibration marker for calibrating a three-dimensional printer. The method includes the steps of providing an image of a calibration marker to the three-dimensional printer; forming a calibration marker based on the provided image by depositing toner material on a first substrate of the printer, the calibration marker having a feature size and being fully interconnected to impart structural integrity to the calibration marker, and having annular spectral energy concentrated at a radius determined by the feature size of the calibration marker, wherein the interconnectedness and feature size of the calibration marker enables the structural integrity of the calibration marker to be maintained during transfer; transferring the formed calibration marker from the first substrate to a second substrate of the printer; and calibrating the printer from a determination of distortion introduced to the calibration marker during the forming and the transferring of the calibration marker.

### REFERENCE TO RELATED PATENT APPLICATION

This application claims the benefit under 35 U.S.C. §119 of the filing date of Australian Patent Application No. 2015234328, filed Sep. 30, 2015, hereby incorporated by reference in its entirety as if fully set forth herein.

### TECHNICAL FIELD

Aspects of the present disclosure relate to three-dimensional printing, known as additive manufacturing, and more particularly to a calibration marker pattern and a method for using the calibration marker pattern to calibrate a three dimensional printer.

### BACKGROUND

In three-dimensional (3D) printing, 3D object models are decomposed into a stack of horizontal cross-section slice images, which are rendered as solid material in a thin layer. The solid material layer is transferred from one part of the printing device to another part by a transfer process before the solid material layers are fused onto a final substrate. Distortions in a solid material layer may occur during the transfer and development process due to misalignment of transfer components (e.g., rollers), and inconsistent motor speed.

FIG. 1 provides an illustration of a solid material layer being distorted during transfer. Specifically, FIG. 1 shows an ideal printed layer of solid material 110 before the transfer process and a distorted layer 130 affected by rotation, scaling and/or shearing after the layer is transferred to an XY stage 120, prior to fusing.

To correct such distortions, a three-dimensional printer is often calibrated before a printing job. Calibration markers are used for this calibration. Particularly, a calibration marker pattern may be generated and rendered onto the final substrate of the printing device. The rendered calibration pattern is then detected by an imaging sensor and compared with the original calibration pattern. Comparison information is used to generate a correction transform or warp map to correct the distortions. The warp map is subsequently applied to future renderings of the printer.

Some commonly utilized 2D calibration patterns for generating a warp map include solid squares, crosses, or spiral patterns. Typically, the accuracy of the generated warp map depends on the properties of the calibration pattern, such as size, shape, and frequency of the features in the calibration pattern. For example, patterns with a large number of high frequency components, such as patterns having multiple corners and edges, create more accurate warp maps than patterns with less number of high frequency components (e.g., squares and crosses). Although patterns with multiple high frequency components produce more accurate warp maps, they are often problematic to use in 3D printing. This is because, in some 3D printers, the solid material layer is not printed directly on a substrate, but transferred through rollers and belts to a platen of the printer. Once calibration is complete, the calibration marker must be removed from the platen. Typical patterns with multiple high frequency components are not robust enough to survive the transfer process or the final removal. Consequently, portions of traditionally used patterns may get stuck in the rollers or on the belt during the transfer or remain stuck to the platen when the calibration marker is removed.

Accordingly, there exists a need for calibration markers for 3D printing that accurately correct geometric distortion and are robust enough to survive the transfer process.

### SUMMARY

Aspects of the present disclosure provide a calibration marker for 3D printers and especially for 3D printers with rotating drums and/or belts. The disclosed calibration markers accurately correct geometric distortions introduced by the printer and are robust enough to survive the transfer process. Specifically, aspects of the present disclosure provide a fully interconnected calibration marker that is structurally strong enough to be peeled off in one piece during transfer/removal from the rotating drum or belt. Furthermore, the calibration marker disclosed herein has spectral energy concentrated substantially annularly at a predetermined radius from an origin in a frequency domain representation of the calibration marker, thereby affording high alignability.

According to a first aspect of the present disclosure a method is provided for calibrating a three-dimensional printer. The method comprises providing an image of a calibration marker to the three-dimensional printer; forming a calibration marker based on the provided image by depositing toner material on a first substrate of the printer, the calibration marker having a feature size and being fully interconnected to impart structural integrity to the calibration marker, and having annular spectral energy concentrated at a radius determined by the feature size of the calibration marker, wherein the interconnectedness and feature size of the calibration marker enables the structural integrity of the calibration marker to be maintained during transfer; transferring the formed calibration marker from the first substrate to a second substrate of the printer; and calibrating the printer from a determination of distortion introduced to the calibration marker during the forming and the transferring of the calibration marker.

According to a second aspect of the present disclosure, calibration marker is provided which is formed by depositing toner material as a layer on a substrate of a three-dimensional printer. The calibration marker includes deposited toner material forming a pattern having fully interconnected features that enable structural integrity of the calibration marker to be maintained during removal of the calibration marker from the substrate. The calibration marker has spectral energy concentrated substantially annularly at a predetermined radius from an origin in a frequency domain representation of the calibration marker.

According to a third aspect of the present disclosure, a non-transitory recording medium is provided. The recording medium comprises a two-dimensional calibration marker of pixel values recorded thereon. The calibration marker comprises a plurality of fully interconnected features of a predetermined size, and has an annular spectral energy spectrum concentrated at a radius determined by the predetermined feature size.

According to a fourth aspect of the present disclosure, a system for calibrating a three-dimensional printer is provided. The system comprises a memory for storing data and a computer program; and a processor coupled to the memory for executing the computer program. The computer program comprises instructions for: generating an image of a calibration marker, the calibration marker having a pattern including fully interconnected features and having annular spectral energy concentrated at a radius determined by a size of the fully interconnected features; transmitting the image of the calibration marker to the three-dimensional printer for forming the calibration marker; receiving an image of the formed calibration marker from the three-dimensional printer; comparing the image of the formed calibration marker with the image of the calibration marker to determine a distortion model representing the distortion introduced to the calibration marker during formation of the calibration marker; slicing a three-dimensional model into a plurality of image slices; and applying the distortion model to each of the image slices.

According to a fifth aspect of the present disclosure, a computer readable storage medium is provided having a computer program recorded thereon for calibrating a three-dimensional printer. The program includes code for generating an image of a calibration marker, the calibration marker having a pattern including fully interconnected features and having annular spectral energy concentrated at a radius determined by a size of the fully interconnected features; code for transmitting the image of the calibration marker to the three-dimensional printer for forming the calibration marker; code for receiving an image of the formed calibration marker from the three-dimensional printer; code for comparing the image of the formed calibration marker with the image of the calibration marker to determine a distortion model representing the distortion introduced to the calibration marker during formation of the calibration marker; code for slicing a three-dimensional model into a plurality of image slices; and code for applying the distortion model to each of the image slices.

According to a sixth aspect of the present disclosure, a system for calibrating a three-dimensional printer is provided. The system includes a controller configured to receive an image of a calibration marker; an image generation unit configured to form a calibration marker based on the image of the calibration marker by depositing toner material on a first substrate, the formed calibration marker having a pattern including fully interconnected features, and having annular spectral energy concentrated at a radius determined by a size of the fully interconnected features; a transfer unit configured to transfer the formed calibration marker from the first substrate to a second substrate without tearing; a sensor configured to capture an image of the formed calibration marker; and a computing system configured to compare the image of the formed calibration marker with the image of the calibration marker to determine a distortion model representing the distortion introduced to the calibration marker during formation and transfer of the calibration marker.

### BRIEF DESCRIPTION OF THE DRAWINGS

One or more embodiments of the invention will now be described with reference to the following drawings, in which:

FIG. 1 is a schematic diagram illustrating distortion in a single printed slice;

FIG. 2 is a schematic block diagram of a 3D printer according to an aspect of the present disclosure;

FIG. 3 is an illustration of a typical calibration marker and its Fourier transform;

FIG. 4 is an illustration of an exemplary calibration marker and its Fourier transform according to an aspect of the present disclosure;

FIG. 5A is a schematic flow diagram illustrating a method of generating a calibration marker according to an aspect of the present disclosure;

FIG. 5B is a schematic flow diagram illustrating a method for improving the connectivity of a binary noise pattern according to an aspect of the present disclosure;

FIG. 6 illustrates a calibration chart according to an aspect of the present disclosure;

FIG. 7 is a flowchart illustrating a method for calibration a 3D printer according to an aspect of the present disclosure;

FIG. 8 is an illustration of the slice correction process according to an aspect of the present disclosure;

FIG. 9 is a schematic flow diagram illustrating a method of measuring slice distortion according to an aspect of the present disclosure;

FIG. 10 is a schematic flow diagram illustrating a method of slice distortion correction according to an aspect of the present disclosure;

FIG. 11 is an illustration of the shift estimate calculated between two image patches; and

FIGS. 12A and 12B form a schematic block diagram of a general-purpose computer system with which the presently disclosed methods to generate a calibration marker and calibrate a 3D printer may be practised.

FIG. 13 is a diagram depicting a typical binarised noise pattern and a binarized band-pass pattern.

FIG. 14A is a diagram illustrating an exemplary connected pattern.

FIG. 14B is a diagram illustrating an exemplary fully interconnected pattern.

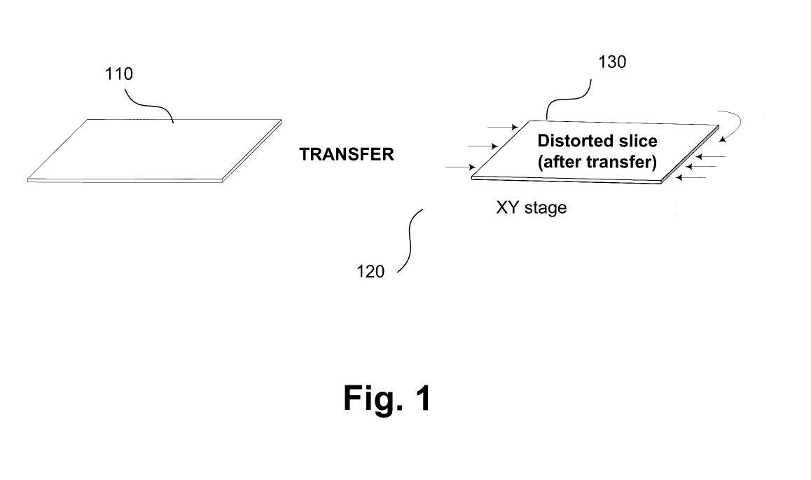

### DETAILED DESCRIPTION

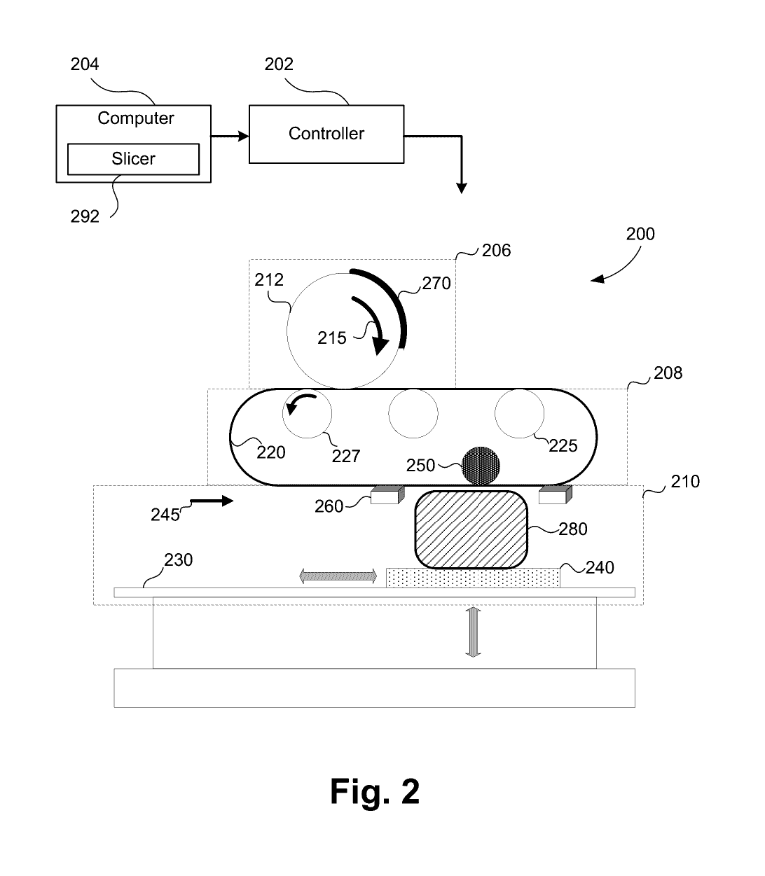

FIG. 2 is a high-level system diagram of an environment where aspects of the present disclosure may be implemented. Particularly, FIG. 2 illustrates a 3D printer 200, such as an electrophotographic-based 3D printer, controlled by a controller 202 and a host computer 204. The 3D printer 200 constructs three-dimensional objects, such as object 280 by successively printing and stacking thin layers 270 of solid material according to a 3D model.

The 3D printer 200 includes three units, namely an image generation unit 206, a first substrate, such as a transfer unit 208, and a second substrate such as a layering unit 210. The image generation unit 206 comprises one or more photo-sensitive drums 212. The first substrate or transfer unit 208 comprises a transfer belt 220 and one or more transfer rollers 225 and the second substrate or layering unit 210 includes a platen 230, an XYZ linear translation stage 240, a fuser roller 250 and one or more optical sensors 260.

The image generation unit 206 develops a thin layer 270 of toner material on the surface of the drum 212 by attracting toner particles. The transfer unit 208 transfers the developed thin layer 270 from the surface of the drum 212 to the layering unit 210. Finally, the layering unit 210 is configured to fuse the thin layer 270 to an existing 3D printed object 280 in development by applying heat and pressure at the fuser roller 250. The optical sensors 260 are configured to monitor the placement of the layer 270 on the stage 240 for maintaining layer registration accuracy. In one aspect of the present disclosure, the optical sensors 260 are 2D area sensors at a resolution of about 1200 dpi, with a field of view of about 512 by 512 pixels or approximately 10 mm by 10 mm in size. The sensors 260 can be colour or monochrome sensors. Alternatively, line or spot sensors may be used, depending on stage configuration, cost and speed requirements.

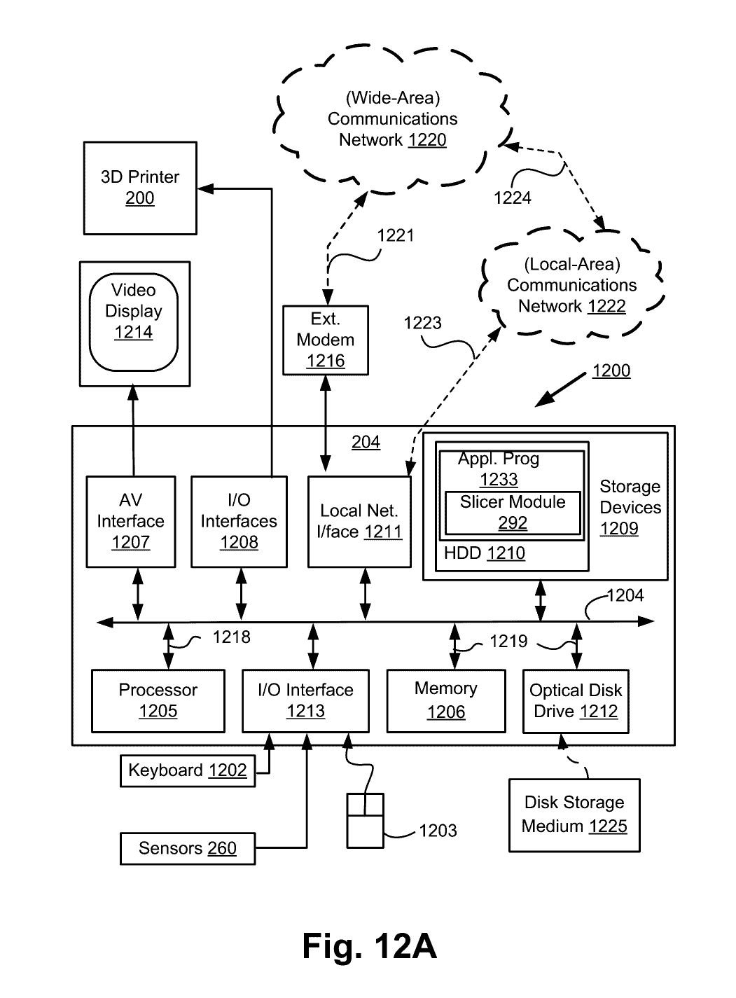

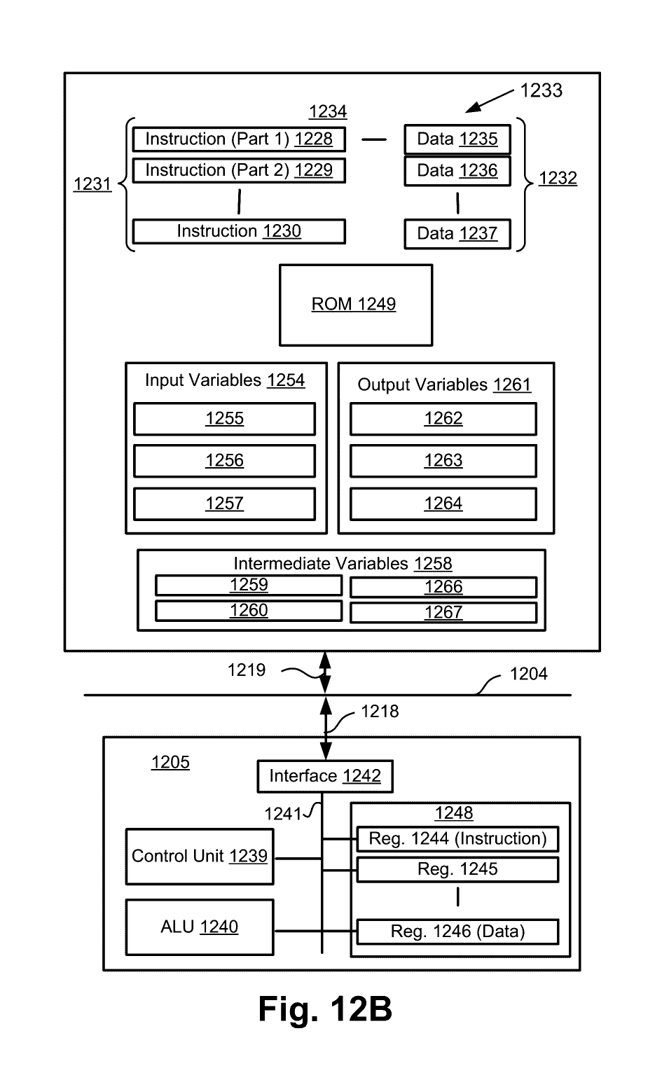

FIGS. 12A and 12B depict a general-purpose computer system 1200, upon which the various arrangements described can be practiced. As seen in FIG. 12A, the computer system 1200 includes: the host computer 204; input devices such as a keyboard 1202, a mouse pointer device 1203, a scanner 1226, and the sensors 260; and output devices such as the 3D printer 200, and a display device 1214. An external ModulatorDemodulator (Modem) transceiver device 1216 may be used by the computer module 204 for communicating to and from a communications network 1220 via a connection 1221.

The communications network 1220 may be a wide-area network (WAN), such as the Internet, a cellular telecommunications network, or a private WAN. Where the connection 1221 is a telephone line, the modem 1216 may be a traditional “dial-up” modem. Alternatively, where the connection 1221 is a high capacity (e.g., cable) connection, the modem 1216 may be a broadband modem. A wireless modem may also be used for wireless connection to the communications network 1220.

The computer module 1201 typically includes at least one processor unit 1205 and a memory unit 1206 including random access memory (RAM) and read only memory (ROM). The computer module 1201 also includes an number of input/output (I/O) interfaces including: an audio-video interface 1107 that couples to the video display 1214; an I/O interface 1213 that couples to the keyboard 1202, mouse 1203, and sensors 260 and optionally a joystick or other human interface device (not illustrated); and an interface 1208 for the external modem 1216 and the 3D printer 200. In some implementations, the modem 1216 may be incorporated within the host computer 204, for example within the interface 1208. The host computer 204 also has a local network interface 1211, which permits coupling of the computer system 1200 via a connection 1223 to a local-area communications network 1222, known as a Local Area Network (LAN). As illustrated in FIG. 12A, the local communications network 1222 may also couple to the wide network 1220 via a connection 1224, which would typically include a so-called “firewall” device or device of similar functionality.

The I/O interfaces 1208 and 1213 may afford either or both of serial and parallel connectivity. Storage devices 1209 are provided and typically include a hard disk drive (HDD) 1210. Other storage devices such as a floppy disk drive and a magnetic tape drive (not illustrated) may also be used. An optical disk drive 1212 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 1200.

The components 1205 to 1213 of the host computer 204 typically communicate via an interconnected bus 1204 and in a manner that results in a conventional mode of operation of the computer system 1200 known to those in the relevant art. For example, the processor 1205 is coupled to the system bus 1204 using a connection 1218. Likewise, the memory 1206 and optical disk drive 1212 are coupled to the system bus 1204 by connections 1219. Examples of computers on which the described arrangements can be practised include IBM-PC's and compatibles, Sun Sparcstations, Apple Mac™ or a like computer systems.

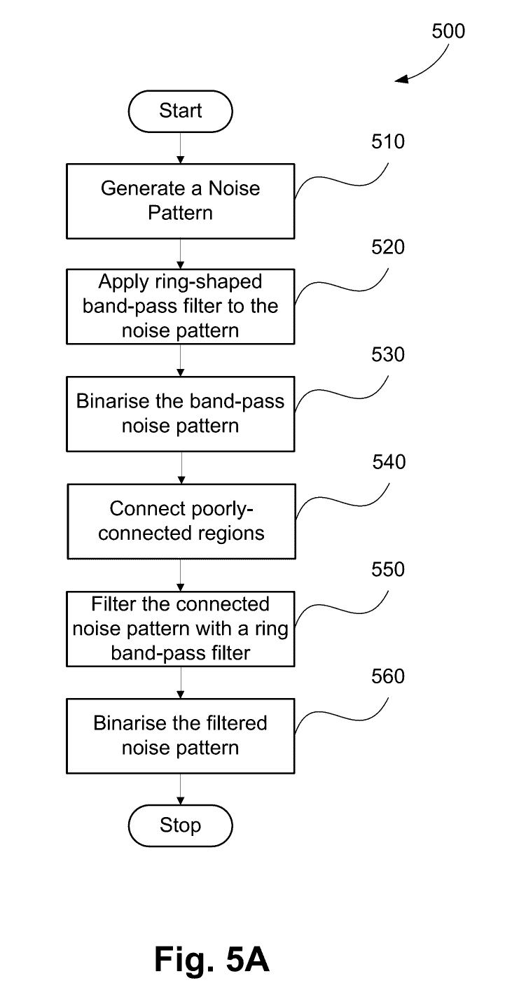

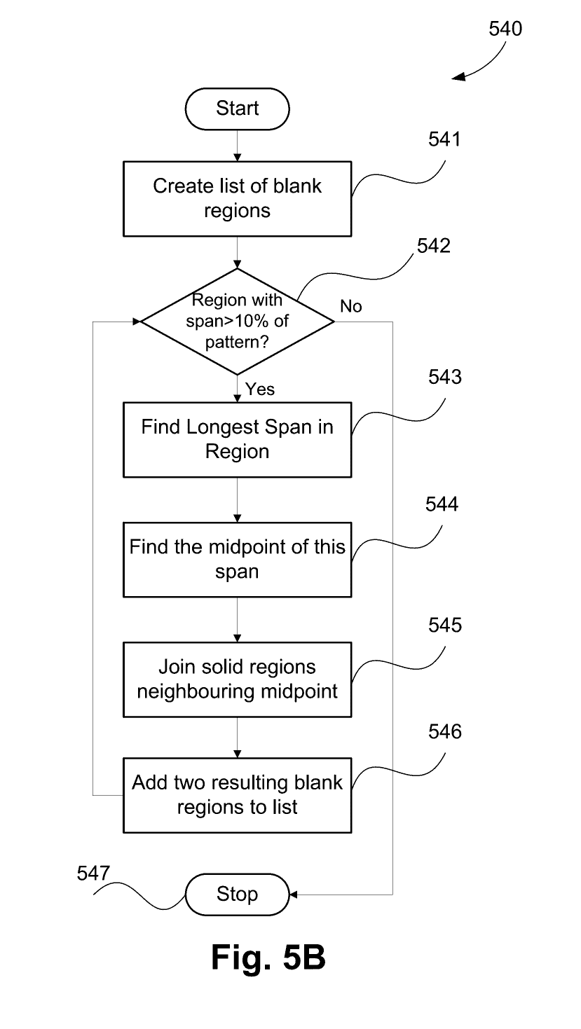

The methods of generating a calibration marker and methods of calibrating the 3D printer 200 with the generated calibration marker may be implemented using the computer system 1200 wherein the processes of FIGS. 5, 7, 9 and 10 to be described, may be implemented as one or more software application programs 1233 executable within the computer system 1200. In particular, the steps of the calibration and marker generation methods are effected by instructions 1231 (see FIG. 12B) in the software 1233 that are carried out within the computer system 1200. The software instructions 1231 may be formed as one or more code modules, each for performing one or more particular tasks. For example, one code module may be the slicer module 292 that is configured to slice a 3D model into multiple image slices. Another code module. The software may also be divided into two separate parts, in which a first part and the corresponding code modules generate the calibration marker and calibrate the 3D printer 200 and a second part and the corresponding code modules provide instructions to the controller 202 to control function of the 3D printer.

The software may be stored in a computer readable medium, including the storage devices described below, for example. The software is loaded into the computer system 1200 from the computer readable medium, and then executed by the computer system 1200. A computer readable medium having such software or computer program recorded on the computer readable medium is a computer program product. The use of the computer program product in the computer system 1200 preferably effects an advantageous apparatus for determining a configuration for inter-processor communication for a heterogeneous multi-processor system.

Alternatively, the software 1233 may be stored in the HDD 1210 or the memory 1206. The software is loaded into the computer system 1200 from the memory, and executed by the computer system 1200. Thus, for example, the software 1233 may be stored on an optically readable disk storage medium (e.g., CD-ROM) 1225 that is read by the optical disk drive 1212.

In some instances, the application programs 1233 may be supplied to the user encoded on one or more CD-ROMs 1225 and read via the corresponding drive 1212, or alternatively may be read by the user from the networks 1220 or 1222. Still further, the software can also be loaded into the computer system 1200 from other computer readable media. Computer readable storage media refers to any non-transitory tangible storage medium that provides recorded instructions and/or data to the computer system 1200 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the host computer 204. Examples of transitory or non-tangible computer readable transmission media that may also participate in the provision of software, application programs, instructions and/or data to the host computer 204 include radio or infra-red transmission channels as well as a network connection to another computer or networked device, and the Internet or Intranets including e-mail transmissions and information recorded on Websites and the like.

The second part of the application programs 1233 and the corresponding code modules mentioned above may be executed to implement one or more graphical user interfaces (GUIs) to be rendered or otherwise represented upon the display 1214, or to provide instructions to the controller 202 of the 3D printer 200. Through manipulation of typically the keyboard 1202 and the mouse 1203, a user of the computer system 1200 and the application may manipulate the interface in a functionally adaptable manner to provide controlling commands and/or input to the applications associated with the GUI(s) and the controller 202.

FIG. 12B is a detailed schematic block diagram of the processor 1205 and a “memory” 1234. The memory 1234 represents a logical aggregation of all the memory modules (including the HDD 1209 and memory 1206) that can be accessed by the host computer 204 in FIG. 12A.

As shown in FIG. 12B, the processor 1205 includes a number of functional modules including a control unit 1239, an arithmetic logic unit (ALU) 1240, and a local or internal memory 1248, sometimes called a cache memory. The cache memory 1248 typically includes a number of storage registers 1244-1246 in a register section. One or more internal busses 1241 functionally interconnect these functional modules. The processor 1205 typically also has one or more interfaces 1242 for communicating with external devices via the system bus 1204, using a connection 1218. The memory 1234 is coupled to the bus 1204 using a connection 1219.

The application program 1233 includes a sequence of instructions 1231 that may include conditional branch and loop instructions. The program 1233 may also include data 1232, which is used in execution of the program 1233. For instance, the program 1233 may include a calibration chart as data 1232. The instructions 1231 and the data 1232 are stored in memory locations 1228, 1229, 1230 and 1235, 1236, 1237, respectively. Depending upon the relative size of the instructions 1231 and the memory locations 1228-1230, a particular instruction may be stored in a single memory location as depicted by the instruction shown in the memory location 1230. Alternately, an instruction may be segmented into a number of parts each of which is stored in a separate memory location, as depicted by the instruction segments shown in the memory locations 1228 and 1229.

In general, the processor 1205 is given a set of instructions, which are executed therein. The processor 1205 waits for a subsequent input, to which the processor 1205 reacts to by executing another set of instructions. Each input may be provided from one or more of a number of sources, including data generated by one or more of the input devices 1202, 1203, data received from an external source across one of the networks 1220, 1222, data retrieved from one of the storage devices 1206, 1209 or data retrieved from a storage medium 1225 inserted into the corresponding reader 1212, all depicted in FIG. 12A. The execution of a set of the instructions may in some cases result in output of data. Execution may also involve storing data or variables to the memory 1234.

The disclosed calibration methods use input variables 1254, which are stored in the memory 1234 in corresponding memory locations 1255, 1256, 1257. The arrangements produce output variables 1261, which are stored in the memory 1234 in corresponding memory locations 1262, 1263, 1264. Intermediate variables 1258 may be stored in memory locations 1259, 1260, 1266 and 1267.

Referring to the processor 1205 of FIG. 12B, the registers 1244, 1245, 1246, the arithmetic logic unit (ALU) 1240, and the control unit 1239 work together to perform sequences of micro-operations needed to perform “fetch, decode, and execute” cycles for every instruction in the instruction set making up the program 1233. Each fetch, decode, and execute cycle comprises:
a fetch operation, which fetches or reads an instruction 1231 from a memory location 1228, 1229, 1230;
(ii) a decode operation in which the control unit 1239 determines which instruction has been fetched; and
(iii) an execute operation in which the control unit 1239 and/or the ALU 1240 execute the instruction.

Thereafter, a further fetch, decode, and execute cycle for the next instruction may be executed. Similarly, a store cycle may be performed by which the control unit 1239 stores or writes a value to a memory location 1232.

Each step or sub-process in the processes of FIGS. 5, 7, 9 and 10 is associated with one or more segments of the program 1233 and is performed by the register section 1244, 1245, 1246, the ALU 1240, and the control unit 1239 in the processor 1205 working together to perform the fetch, decode, and execute cycles for every instruction in the instruction set for the noted segments of the program 1233.

Referring back to FIG. 2, the controller 202 includes one or more microprocessors-based control systems and image processing systems which are designed to operate the 3D printer 200 based on printing instructions received from the host computer 204. The host computer 204 is a computer-based system connected, via a computer network, to communicate with the controller 202 to provide printing data and instructions. Within the host computer 204 is a slicer module 292, which is configured to convert a 3D model into a stack of horizontal cross-section slice images for printing by the 3D printer 200.

The general electrophotography process is based on controlling and transferring charged toner particles through the application of electrostatic forces. The process includes five main steps: 1) charging—the surface of the photosensitive drum 212 is negatively charged with a static charge, 2) exposure—laser beams scan the photosensitive drum 212 to form an image so that areas exposed to the laser beams lose their electrical charge, 3) developing—the toner material is brought in close proximity to the drum 212 and affixes to non-charged areas of the drum, 4) transfer—the photosensitive drum 212 is brought into contact with a substrate and a positive charge is applied from behind, transferring the toner onto the substrate, and 5) fixing—heat and pressure are applied to fix the toner to the substrate.

The 3D printer 200 is designed to transfer the toner material from the drum 212 to the translation stage 240 in two steps: the toner material is first transferred from the surface of the photosensitive drum 212 to the transfer belt 220, and then from the transfer belt 220 to the translation stage 240 or the top of an existing 3D printed object 280. During the transfer steps, the toner particles are held in place through the application of one or more forces such as electrostatic forces, adhesive forces, thermal energy, or mechanical forces.

A problem with the transfer process is that the toner particles are not held together perfectly when there is significant movement in the printer 200, which usually results in two undesirable effects on the transferred layer 270—warping and breakage. Warping or geometrical distortion of the layer 270 (e.g., stretching, rotation, or shearing) is usually caused because of non-uniform relative movement between the toner particles. Breakages usually occur in weakly connected areas of the layer, which causes small amounts of toner particles to be left behind after each transfer movement.

Warping or geometric distortion of the layer 270 can be corrected through a two-step calibration process in which the systematic distortion is first measured to form a parametric distortion model, which is then fed back to either the controller 202 or the host computer 204 for slice correction. The purpose of slice correction is to apply an inverse transformation of the distortion model such that when each slice image is developed and transferred to the translation stage 240, the corresponding solid layer is free from distortion. The slice correction process may be applied directly to existing slice images in the controller 202 or to 3D models at the slicer module 292.

Distortion can be measured by printing a calibration chart containing one or more calibration marker patterns, measuring the locations of those printed markers through the optical sensors 260, and aligning the measured marker locations against reference marker locations.

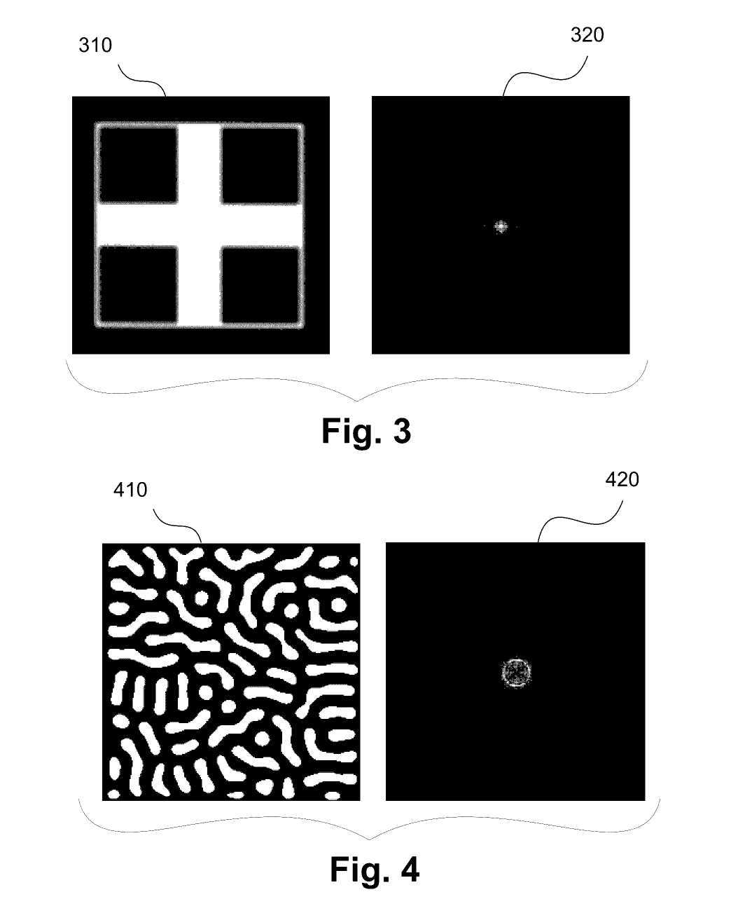

As described previously, various calibration marker patterns are known. Some patterns have relatively few high frequency components such as edges and corners, while other patterns have a relatively large number of high frequency components. Calibration accuracy is highly dependent on the features of the calibration marker pattern. In general, the accuracy of the calibration depends on the frequency and orientation of the features of the calibration marker. The higher the number of high frequency components in a pattern and the more the number of orientations (e.g., isotropic), the more accurate the calibration. Thus, calibration patterns, with fewer high frequency components are not ideal for printer calibration. FIG. 3 illustrates a typical cross calibration marker pattern 302 and a Fourier transform 304 of the pattern. As seen from the Fourier transform 304, most of the signal is concentrated in a small region around the centre of the Fourier transform 304. Alternatively, a blue noise pattern, which has minimal low frequency components, maximum high frequency components, and a stochastic distribution of small features, is a suitable choice for calibration accuracy.

In 3D printing, in addition to calibration accuracy, robustness of a calibration pattern is also important. The previously known patterns with large numbers of high frequency components typically included multiple small isolated features or weakly connected features. When these small isolated features or weakly connected features are printed in toner particles, they are prone to breakages and dropping off during the transfer process. Accordingly, although previously known patterns with large number of high-frequency components may provide accurate calibration, they are not robust enough to survive the transfer process. Examples of such patterns include blue noise patterns.

Furthermore, the Fourier transforms of a closely connected regular grid with fine features contains grid-like features which produce multiple maxima that affect estimation of the warp model. Moreover, a regular grid pattern is not optimised for the printer's modulation transfer function (MTF) to provide the most accurate correlation.

To address these problems, aspects of the present disclosure provide a calibration marker that is robust, provides accurate calibration, and is non-periodic. To that end, a calibration marker according to the present disclosure is isotropic, has multiple high frequency components, includes small features that have strong interconnectivity to maintain structural integrity during the transfer process, is scalable and has a minimum marker size that is printable by the 3D printer.

The calibration pattern of the present disclosure has annular spectral energy. Particularly, the Fourier transform of the calibration marker is a single thin ring in a medium-high band of the system's MTF, providing a strong concentration of medium-high frequency features that are isotropic.

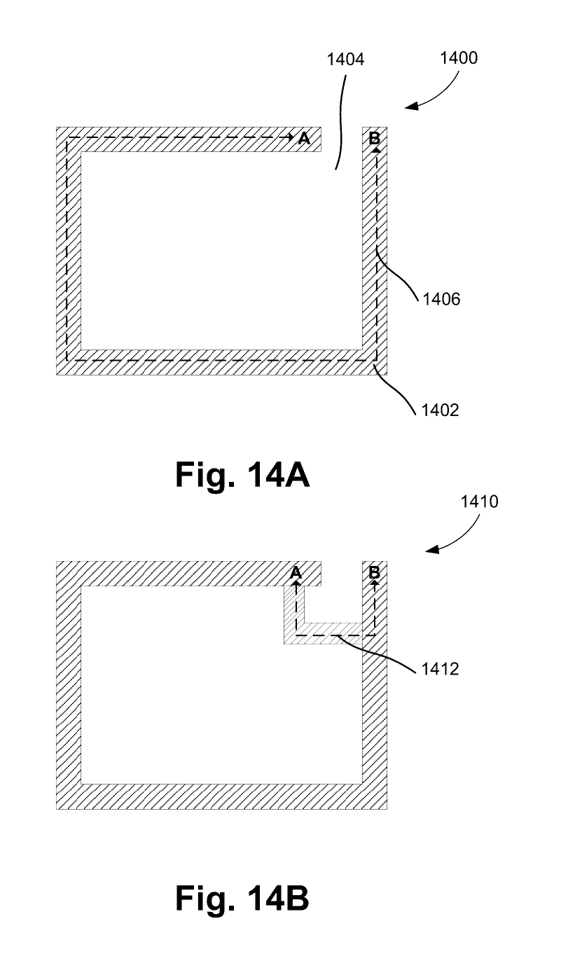

In order to be structurally strong, the features of a calibration marker pattern according to the present disclosure are fully interconnected and surrounded by a solid border. The calibration marker pattern is binary and consists of solid features, including toner material, and blank features, which do not include toner material. As referred to herein, ‘connected’ means all solid features are connected together to form a single connected component. Specifically, a solid path exists between any two solid feature points on the calibration marker pattern, joining the two points. FIG. 14A illustrates a connected marker 1400, which has a single solid feature 1402 and a blank feature 1404. Furthermore, a solid path connects any two solid feature points in the marker. For instance, path 1406 connects solid feature points A and B.

In some aspects, the calibration marker pattern is fully interconnected. As used in this disclosure, ‘fully interconnected’ refers to a connected pattern that is closely connected to avoid tearing, i.e., not only is there a material-containing path between any two points, any two nearby points are connected by a relatively short path. In addition, the interior of the pattern does not contain large areas devoid of material. These characteristics are arranged such that when the marker is pulled from the substrate, the marker lifts evenly off the surface. FIG. 14B illustrates a fully interconnected marker 1410. As evident from FIG. 14A, the path 1406 between points A and B is relatively long and therefore, pattern 1400 is not fully interconnected. However, points A and B on the marker 1410 are additionally connected by a shorter path 1412, thus making marker 1410 fully interconnected. In one aspect, a marker pattern is considered to be fully interconnected when for features closer together than 10% of the width of the pattern, the length of a path joining those features is not greater than 20% of the width of the pattern, and there are no areas devoid of material inside the pattern and also greater than 20% of the width of the pattern.

The calibration marker pattern of the present disclosure also has a spread-spectrum with sufficiently high frequency components that are not so high that they are unprintable or are affected by modulation transfer function (MTF) attenuation and noise of the optical sensor. Also, the features are in multiple orientations.

An example marker pattern with the above desirable characteristics is shown in FIG. 4. The pattern 410 has a predetermined feature size and all the features are fully interconnected such that there is a short path between any two nearby junction points to provide strong structural strength when printed. A pattern containing only short paths between connections is called “strongly connected” and a pattern containing long paths is called “weakly connected”. The Fourier transform 420 of the marker pattern 410, also shown in FIG. 4, is an annular spectral energy concentrated at a radius that is determined by the feature size. The marker pattern 410 satisfies the conflicting requirements for structural strength and strong alignment features. The feature size can be determined empirically by performing a breakage test using printed markers of various sizes. In a preferred embodiment, the minimum feature size is 100 μm.

Generally, the radius of the annular spectral energy is inversely proportional to the feature size such that increasing the radius has the effect of reducing the feature size. So for a given minimum feature size, there is a corresponding maximum radius of annular spectrum energy. For accurate alignment, a large radius is preferred. However, for strong structural strength a large feature size is preferred. Thus, a suitable trade-off is required to satisfy both alignment and structural strength requirements. Furthermore, the width of the ring in the Fourier transform 420 controls the range of feature sizes in the spatial domain. A thin ring corresponds to features that are substantially of the same size; while a thick ring corresponds to features with a range of sizes.

Aspects of the present disclosure utilize the marker pattern 410 for calibrating the 3D printer 200 that requires transferring the printed marker pattern 410 from one surface to another. The interconnectivity and feature size of the marker pattern 410 enables the structural integrity of the marker to be maintained during transfer. A determination of distortion introduced to the marker pattern 410 during formation and transfer can be made to compensate for any systematic distortion in the creation of 3D objects by the 3D printer 200.

FIG. 5A illustrates a method 500 for creating a fully interconnected calibration marker pattern with an annular spectral energy. This method will be described with reference to FIGS. 12A and 12B. In one arrangement, the steps of the method 500 may be implemented as one or more software code modules of the software application program 1233 resident in the ROM 1260 and being controlled in execution by the processor 1205 of the system 1200. Moreover, one or more method steps may be deleted, added, or reordered without departing from the scope of the present disclosure.

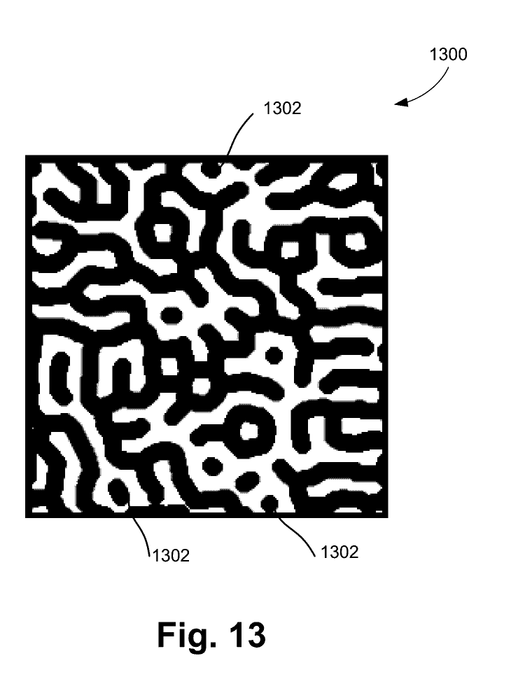

First at step 510, the processor 1205 generates a noise pattern of approximately the size of a calibration marker in the Fourier domain. Typical sizes of calibration markers are 5 mm by 5 mm, but the size used in any particular system would depend upon various properties of the system such as the optics, material properties, rendering resolution and sensor resolution. In a preferred embodiment, the noise pattern is generated using Gaussian noise. However, other types of noise such as uniformly distributed noise or blue noise may also be used. FIG. 13 illustrates an exemplary binarised noise pattern 1310 that may be generated by the processor 1205 at this step. At step 520, the processor 1205 applies a ring-shaped band-pass filter to the noise pattern 1310. The ring-shaped band-pass filter has a Fourier domain radius that is predetermined by the required spatial feature size to the noise pattern by multiplying the band-pass filter with the noise pattern and applying an inverse Fourier transform to the product to produce a band-pass noise pattern.

Subsequently, at step 530, the band-pass noise pattern is binarised to produce a binary noise pattern 1320, where the two pixel values represent “filled” or “blank” spaces of the pattern, with spectral energy substantially concentrated at a specific radius from the origin in the frequency domain. The radius of the spectral energy is based on the predetermined feature size selected at step 520.

The binary noise pattern 1320 generated at step 530 may include a number of disjointed and weakly connected features such as isolated islands and weakly connected paths as seen in 1320.

At step 540, the disjointed or weakly connected binary noise pattern is modified into a fully interconnected binary pattern by converting some “blank” pixels to “filled” pixels. The step 540 is considered complete when all the features in the pattern are fully interconnected. However, care must be exercised while connecting the disjointed features to avoid over-connecting features, which would destroy or damage the annular spectral energy of the marker.

After forming an initial fully interconnected binary pattern with an annular spectral energy, two refining steps 550 and 560 are applied to the binary pattern to improve the annular characteristic of its Fourier transform. At step 550, the fully interconnected binary pattern is filtered by the same ring-shaped band-pass filter of step 520. Refiltering the binary pattern can repair damage to the annular spectral energy without causing disconnection of the components. Finally, at step 560, the filtered pattern is once again binarised so that “filled” pixel values contain physical material and “blank” pixel values do not. The steps in method 500 may be performed in a different order or with more iterations to improve the connectivity or annular spectral energy characteristics of the generated pattern.

FIG. 5B illustrates one method to improve the connectivity of the binary noise pattern as described in step 540. The method begins at step 541, where a list is generated that includes all the blank regions in the binary noise pattern. Each such region includes a group of blank connected pixels, and no two blank regions are connected to each other.

At step 542, the list is examined to determine if any of the listed blank regions contain a span of pixels greater than 10% of the width of the binary noise pattern. If no such blank region is found, the binary noise pattern is regarded as fully interconnected, and the method 5B finishes at step 547. Alternatively, if such a blank region is found, the method identifies the longest span in the selected blank region at step 543. Subsequently, the mid-point of the longest span is determined at step 544. The marker pattern is then modified to insert filled pixel values around the determined midpoint so as to join two neighbouring filled regions, separated by the blank region.

The method 5B bisects the blank region and creates two smaller blank regions, which can be added back into the list of blank regions in step 546. The process iterates by returning to step 542 until no blank regions exist that contain a span of pixels greater than 10% of the pattern width. When the method is completed, not only is the pattern connected, but it is fully interconnected.

It will be understood that FIGS. 5A and 5B depict one method of generating a calibration marker and that other methods may also be utilized to generate calibration markers with desired connectivity and annual spectral energy properties without departing from the scope of the present disclosure. For example, calibration markers may be generated by using iterative optimisation methods such as simulated annealing, particle swarm optimisation, stochastic gradient descent, genetic search algorithms or graph cut methods. In these methods, a pattern is generated according to a cost function, being a function of the connectivity and/or strength of features and of the spectral energy within the defined annular region.

For example, a calibration marker pattern can be created by placing multiple non-overlapping line segments of a selected width at random locations, and randomly joining the line segments with nearby lines until the pattern is fully interconnected. The spectrum and the mechanical strength of the created pattern can be measured as the value of a cost function. An example of a cost function representing a desired spectrum may be the ratio of the energy spectrum of the pattern at a desired frequency radius to the energy spectrum of the pattern at all other locations in the spectrum with an offset added to each energy spectrum to avoid becoming identically zero, i.e. (E(undesired spectrum)+ε)/(E(desired spectrum)+ε). Binarizing the pattern to values of ±1 can prioritize patterns including an equal amount of space for blank regions and filled regions. An example of a cost function representing desirable connectivity/mechanical strength is the maximum length of a blank region in the interior of the pattern. By minimizing both cost functions together, e.g. by minimizing the sum of the spectrum and mechanical strength cost functions, an effective calibration marker can be generated.

To improve the calibration marker, the position of line segments and connections between lines can be varied using a technique such as simulated annealing, with the cost function re-evaluated for each arrangement, and with the parameters defining the process, such as number of lines, line width, length, orientation and random seed, which give the lowest cost, being preferentially selected. Such techniques are known to converge, albeit slowly, to an optimum solution.

Where the physical properties of the process and materials of the calibration marker is not known, measurements of the physical strength and alignability of generated patterns can be empirically determined using actual test prints, with the accuracy and alignability of the results forming part of the cost function and the optimisation process.

The calibration pattern generated by method 500 may be utilized to generate a calibration chart. Furthermore, the calibration pattern and the calibration chart may be stored in memory 1206, be transmitted to the controller 202 when requested, or be stored in a memory associated with the 3D printer 200 for future use.

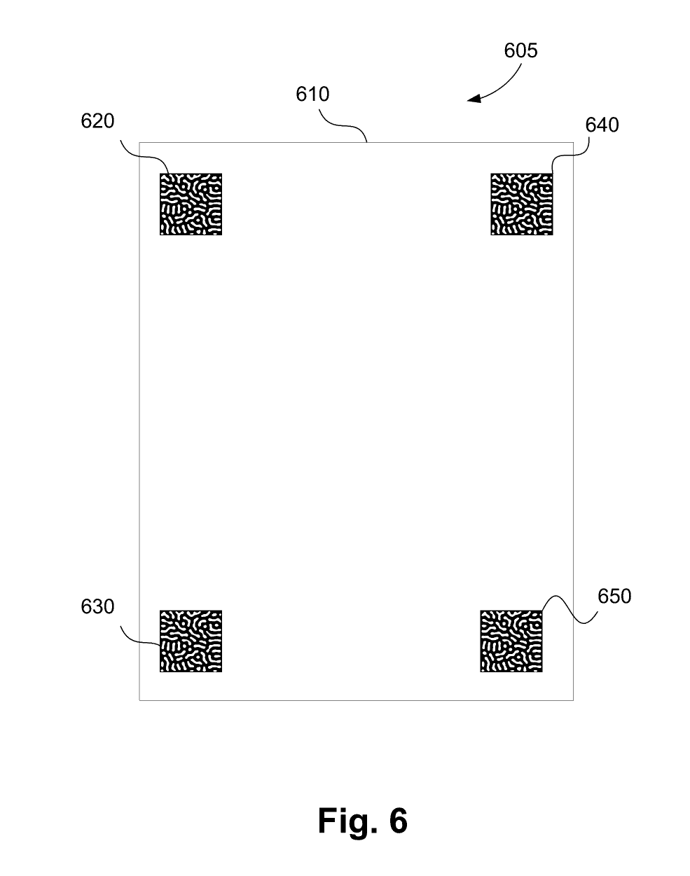

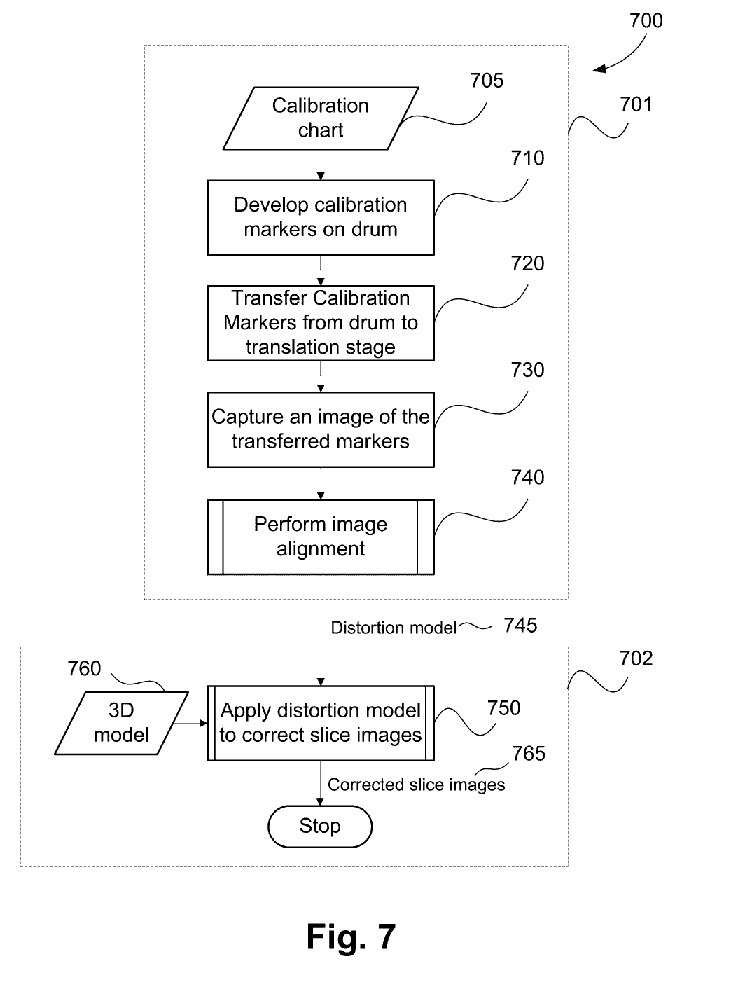

FIG. 6 illustrates an example calibration chart 605 including four calibration marker patterns 620, 630, 640 and 650 that can be printed as a single solid layer of toner particles by the 3D printer 200 for performing offline calibration as described with reference to FIG. 7. In one aspect, the calibration chart 605 is an A4 size image 610 at a resolution of about 1200 dpi. The four marker patterns 620-650, located one at each corner as shown in FIG. 6, are approximately 5 mm by 5 mm in size with a 5 mm margin from their nearest borders. Further, the size of the marker patterns 620-650 and the margins from the borders may also be varied without departing from the scope of the present disclosure. For instance, the size of the calibration markers 620-650 may be 10 mm by 10 mm and the markers may be located 3 mm from the closest borders. It will also be understood that the calibration markers need not be located in the corners of the calibration chart, but may be located at any other locations on the calibration chart without departing from the scope of the present disclosure. It is desirable for the calibration chart 610 to include enough markers or large enough markers to estimate a robust distortion model.

Furthermore, the calibration marker patterns 620-650 may be printed as a single solid layer of toner particles or may be printed as several layers, forming a 3D object 280.

The calibration chart 610 is utilized to calibrate the 3D printer 200. FIG. 7 is a flowchart illustrating a method 700 for calibrating a 3D printer, such as 3D printer 200. This method will be described with reference to FIGS. 2, 7, 12A and 12B. In one arrangement, one or more steps of the method 700 may be implemented as one or more software code modules of the software application program 1233 resident in the ROM 1260 and being controlled in execution by the processor 1205 of the system 1200. Other steps of the method 700 may be performed by the controller associated with the 3D printer. Moreover, one or more method steps may be deleted, added, or reordered without departing from the scope of the present disclosure.

The calibration method 700 includes two stages: distortion measurement 701 and slice image correction 702. The distortion measurement stage 701 begins at step 710, where the host computer 204 provides an image of a calibration chart, such as the calibration chart 605 of FIG. 6. Specifically, the image of the calibration chart is provided to the controller 202, which forms one or more calibration markers, such as calibration markers 620-650, by depositing toner material on the surface of the drum 212 of the 3D printer 200 using the electrophotographic process as described above.

At step 720, the formed calibration markers 270 (thin solid material layer 270 in FIG. 2) are transferred from the drum 212 to the first substrate or translation stage 240 by movement of the mechanical parts of the 3D printer 200. Particularly, as the drum 212 rotates in the direction of arrow 215 in synchronisation with the transfer rollers 225 moving in the direction of arrow 227, the formed calibration markers 270 are gradually transferred onto the transfer belt 220. As the transfer rollers 225 continue to rotate in the direction of arrow 227 and the translation stage 240 moves in synchronisation from left to right in the direction of 245, the formed calibration markers 270 are gradually transferred onto the surface of the translation stage 240.

After the developed markers 270 land on the surface of the translation stage 240, the translation stage 240 continues to move in the direction of arrow 245. When the translation stage 240 reaches a predetermined reference position, the controller 202 triggers the sensors 260 to capture images of the developed markers 270 at step 730. The reference position represents an ideal marker placement location, where in the absence of any geometric distortion each marker pattern would appear in the centre of the corresponding captured image. However, during the offline calibration process the marker patterns within the captured images are likely to have deviated from their nominal positions due to the presence of geometric distortion. The captured marker images may be referred to as target images.

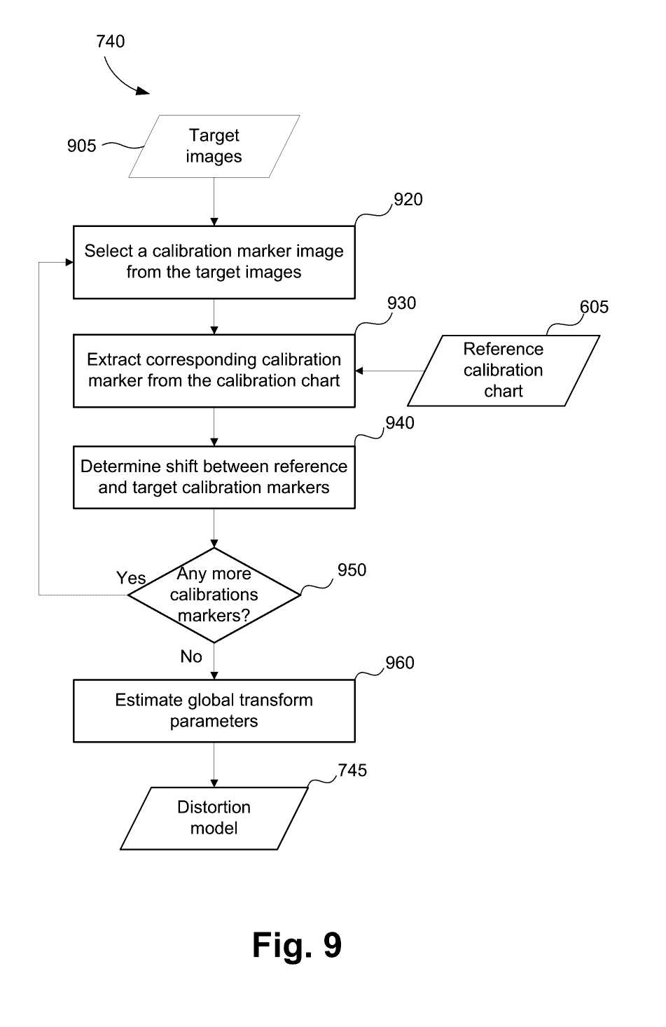

The controller 202 transmits the captured target images to the host computer 204. At step 740, the processor 1205 associated with the host computer 204 extracts a set of corresponding digital marker images 620-650 from the calibration chart 605 for the target images. The images may be extracted from the memory 1206. The extracted digital marker images 620-650 represent ideal images of the markers if there was no distortion; and they are referred to as ‘reference images’. The processor 1205 then retrieves an alignment program from the memory and executes that program to align the reference and target images and to determine a distortion model 745 representing the geometric distortion present in the rendered calibration markers 270. The image alignment step 740 is described in detail with reference to FIG. 9.

The distortion measurement step 701 may be performed as a one-off calibration step or at regular service intervals. In some applications, the distortion measurement step 701 may be performed prior to printing each new 3D object. Independently from the distortion measurement step 701, the slice image correction step 702 is performed for every print job.

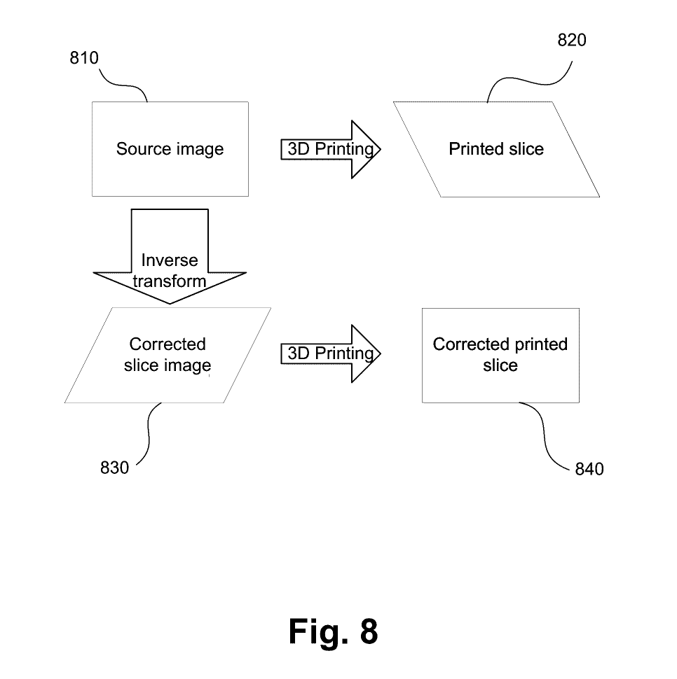

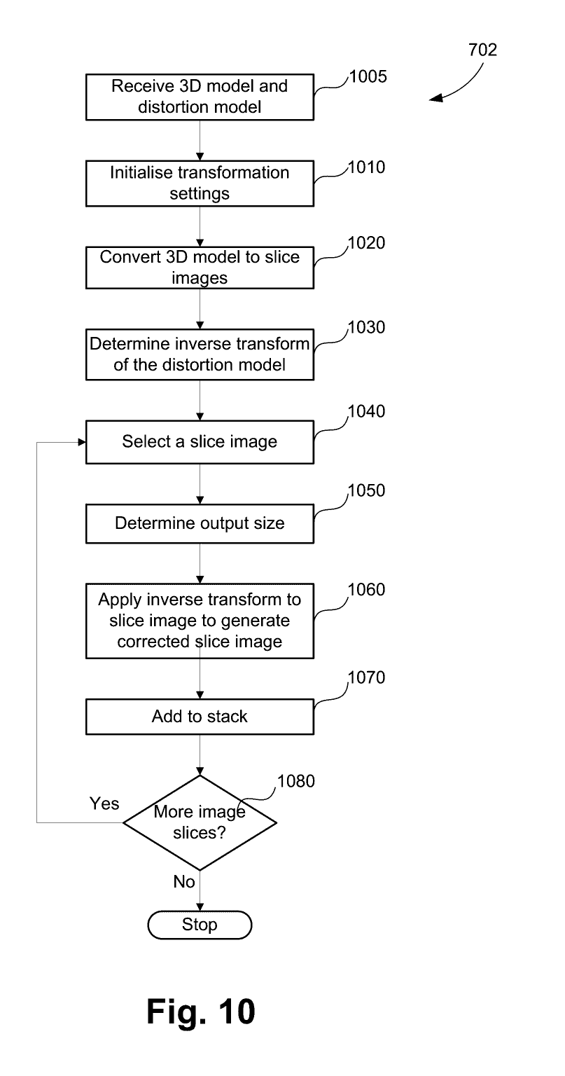

The slice image correction stage 702 begins at step 750 where the host computer 204, via the slicer module 292, applies geometric transformation based on the distortion model 745 to the slices of a 3D model 760 to obtain a stack of horizontal cross-section slice images 765. The corrected slice images 765 are transmitted to the controller 202 to direct the 3D printer 200 to produce a distortion-free 3D object of the 3D model 760. The image correction step 750 will be described in detail with reference to FIGS. 8 and 10.

FIG. 8 is a graphical illustration of the offline calibration method 700. A goal of the calibration method is to estimate a distortion model in printed layers 270 and use the distortion model to correct distortions in the printed layers 270 by applying an inverse transformation of the distortion model to the images of the source layer such that the final printed layers 270 match their original images. In the example illustrated in FIG. 8, a source rectangular layer image 810 becomes sheared once printed as a solid layer 820. In order to remove this shearing, a distortion model is estimated by aligning the source layer image 810 with a target image of the printed layer image 820. An inverse transformation of the distortion model is applied to the source layer image 810 to generate a corrected layer image 830, which is the source layer image sheared in the opposite direction to the printed layer 820. The corrected layer image 830 is then printed to generate a corrected printed layer 840 with an appearance that matches the source layer image 810.

FIG. 9 is a flowchart illustrating sub steps of step 740, in which the host computer 204 aligns the target and reference images to generate a distortion model. In method 740, a distortion model is generated based on a patch-based parametric motion estimation technique. In this technique, images are aligned based on measurements at small patches located throughout the image. A patch is a small window region of the image that contains alignment features. In other embodiments, the distortion model may be generated using global Fourier alignment, optical flow, spline methods or feature-based methods without departing from the scope of the present disclosure.

In patch-based image alignment, identification of patch regions with strong alignment features is usually a major step of the approach. However, in offline calibration, the calibration marker patterns 620-650 are the alignment features, which are placed at known positions in the calibration chart 605, so there is no need to perform patch selection.

The method of patch-based alignment is ideal for the case of offline calibration. Patch-based methods allow very accurate transform estimates to be made in the case of small rigid deformations. In this case the distortions over small areas in the image are translations only. In addition the shift measurements are robust to additive noise from the sensor and have sub-pixel accuracy.

The method 740 begins at step 920, in which an image of a calibration marker is selected from the target image 905. At step 930, a corresponding source marker pattern is extracted from the reference calibration chart 605 stored in the memory 1206. For example, if the selected captured image is from the top-left corner of the printed slice #270, marker pattern 620 is extracted from the calibration chart 605.

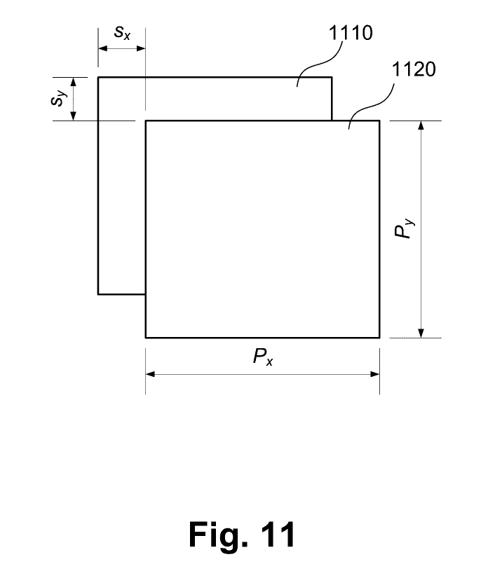

Next, shifts between the reference and target pair of calibration marker images are determined by a shift estimation method such as a correlation-based or gradient-based method at step 940. This step is described with reference to FIG. 11, which shows target and reference patches 1110 and 1120. The shift is the vector s=[sₓ, s_{y}]^{T} of the amount in the horizontal and vertical directions that the reference patch 1110 must be offset from the target patch 1120 to make the area where the reference and target patches overlap the most similar.

Step 950 determines whether there are further calibration marker images to be processed from the target images 905. If there are more calibration marker images to process, the method 740 returns to step 920, where the next calibration marker image is retrieved from the target images 905. Otherwise, the method 740 continues to step 960, where global transform parameters are estimated based on the shift measurements computed for all the calibration pattern pairs at step 940. The global transformation describes the distortion in the printed slice 820.

The shift measurements represent local motion at the corresponding marker locations. It is assumed that these shifts are consistent with some global motion model. Furthermore, it is assumed that distortion on the printed calibration chart can be modelled by an affine transformation, which is a linear mapping that preserves collinearity, and represents rotation, scaling, shearing and translation movement between the reference and target images. However, the distortion may occasionally be non-linear. In these cases, local or non-linear distortion models may be required.

The affine transformation can be expressed with a set of parameters:

$$[ \begin{matrix}{\tilde{x}}_{i} \\ {\tilde{y}}_{i}\end{matrix} ] = [ \begin{matrix}a & b \\ c & d\end{matrix} ] [ \begin{matrix}{x}_{i} \\ {y}_{i}\end{matrix} ] + [ \begin{matrix}e \\ f\end{matrix} ] \qquad ( 1 )$$

where (xᵢ, yᵢ) are points in the reference calibration chart and (\tilde{x}ᵢ, \tilde{y}ᵢ) are the corresponding points after affine transformation.

The shift measurements obtained in step 940 are estimates of displacements from points (xᵢ, yᵢ) to (\tilde{x}ᵢ, \tilde{y}ᵢ):

$$[ \begin{matrix}{\hat{x}}_{i} \\ {\hat{y}}_{i}\end{matrix} ] = [ \begin{matrix}{x}_{i} \\ {y}_{i}\end{matrix} ] + [ \begin{matrix}{s}_{xi} \\ {s}_{yi}\end{matrix} ] \qquad ( 2 )$$

where (\hat{x}ᵢ, ŷᵢ) are estimates of the transformed points (\tilde{x}ᵢ, \tilde{y}ᵢ).

The best fitting affine transformation is determined by minimising the error between the displaced coordinates (\hat{x}ᵢ, ŷᵢ) and the affine transformed points (\tilde{x}ᵢ, \tilde{y}ᵢ) by changing the affine transform parameters (a, b, c, d, e, f). The error functional to be minimised is the Euclidean distance measure E:

$$E = {\sum }_{i = 1}^{N} {( {\hat{x}}_{i} - {\tilde{x}}_{i} )}^{2} + {( {\hat{y}}_{i} - {\tilde{y}}_{i} )}^{2} \qquad ( 3 )$$

The solution of the minimisation is

$$\begin{matrix}[ \begin{matrix}a \\ c \\ e\end{matrix} ] = {M}^{- 1} [ \begin{matrix}\sum {\hat{x}}_{i} {x}_{i} \\ \sum {\hat{x}}_{i} {y}_{i} \\ \sum {\hat{x}}_{i}\end{matrix} ] and [ \begin{matrix}b \\ d \\ f\end{matrix} ] = {M}^{- 1} [ \begin{matrix}\sum {\hat{y}}_{i} {x}_{i} \\ \sum {\hat{y}}_{i} {y}_{i} \\ \sum {\hat{y}}_{i}\end{matrix} ] \\ with & ( 4 ) \\ M = [ \begin{matrix}{S}_{xx} & {S}_{xy} & {S}_{x} \\ {S}_{xy} & {S}_{yy} & {S}_{y} \\ {S}_{x} & {S}_{y} & S\end{matrix} ] = [ \begin{matrix}\sum {x}_{i} {x}_{i} & \sum {x}_{i} {y}_{i} & \sum {x}_{i} \\ \sum {y}_{i} {x}_{i} & \sum {y}_{i} {y}_{i} & \sum {y}_{i} \\ \sum {x}_{i} & \sum {y}_{i} & \sum 1\end{matrix} ] & ( 5 ) \\ {M}^{- 1} = \frac{1}{\vert M \vert} [ \begin{matrix}- {S}_{y} {S}_{y} + {SS}_{yy} & - {SS}_{xy} + {S}_{x} {S}_{y} & {S}_{xy} {S}_{y} - {S}_{x} {S}_{yy} \\ - {SS}_{xy} + {S}_{x} {S}_{y} & - {S}_{x} {S}_{x} + {SS}_{xx} & {S}_{x} {S}_{xy} - {S}_{xx} {S}_{y} \\ {S}_{xy} {S}_{y} - {S}_{x} {S}_{yy} & {S}_{x} {S}_{xy} - {S}_{xx} {S}_{y} & - {S}_{xy} {S}_{xy} + {S}_{xx} {S}_{yy}\end{matrix} ] \\ and & ( 6 ) \\ \vert M \vert = det M = - {SS}_{xy} {S}_{xy} + 2 {S}_{x} {S}_{xy} {S}_{y} - {S}_{xx} {S}_{y} {S}_{y} - {S}_{x} {S}_{x} {S}_{yy} + {SS}_{xx} {S}_{yy} . & ( 7 )\end{matrix}$$

At the end of method 740, the distortion model is output.

FIG. 10 is a flowchart illustrating the slice image correction stage 702 of method 700 in detail. At step 1005, the computer receives a 3D model 760 and the distortion model 745 obtained in method 701. Subsequently, at step 1010, one or more transformation settings are initialised. The transformation settings may include pad mode—each corrected slice image is padded (or expanded) to ensure no clipping of the 3D object is allowed; edge mode—the value of undefined pixels in each corrected slice image is set (the default setting is zero); and interpolation method—the interpolation method for resampling pixel values is set.

At step 1020, the host computer 204 uses the slicer module 292 to convert the 3D model 760 into a stack of horizontal cross-section slice images. An inverse transformation of the distortion model 745 is determined at step 1030. The method 702 then employs a loop to process each slice image of the 3D model 760 in turn, starting at step 1040 where a slice image is selected. In order to avoid trimming off small parts of the 3D object, the output size of each corrected slice image is determined prior to transformation to create an image buffer that is large enough to store the transformed image at step 1050. The inverse transformation determined at step 1030 is applied to the slice image to generate a corrected slice image at step 1060. The corrected slice image is then added to an existing stack of corrected slice images 765 or a new stack if one does not exist at step 1070. Step 1080 checks if there are further source slice images to process, in which case processing returns to step 1040, otherwise the processing of method 702 terminates after step 1080.

The arrangements described herein may be utilized in the computer and data processing industries and particularly in the image processing industry.

The foregoing describes only some embodiments of the present invention, and modifications and/or changes can be made thereto without departing from the scope and spirit of the invention, the embodiments being illustrative and not restrictive.

1. A method for calibrating a three-dimensional printer, said method comprising:
providing an image of a calibration marker to the three-dimensional printer;
forming a calibration marker based on the provided image by depositing toner material on a first substrate of the printer, the calibration marker having a feature size and being fully interconnected to impart structural integrity to the calibration marker, and having annular spectral energy concentrated at a radius determined by the feature size of the calibration marker, wherein the interconnectedness and the feature size of the calibration marker enables the structural integrity of the calibration marker to be maintained during transfer;
transferring the formed calibration marker from the first substrate to a second substrate of the printer; and
calibrating the printer from a determination of distortion introduced to the calibration marker during the forming and the transferring of the calibration marker.

2. The method of claim 1 further comprising generating the image of the calibration marker.

3. The method of claim 2, wherein generating the image of the calibration marker includes:
generating a noise pattern;
applying a ring-shaped band pass filter to the generated noise pattern;
converting the noise pattern into a binary noise pattern having blank pixels and filled pixels;
modifying the binary noise pattern into a fully interconnected binary pattern by converting at least some of the blank pixels into filled pixels.

4. The method of claim 3, wherein generating the image of the calibration marker further comprises:
applying the ring-shaped band pass filter to the fully interconnected binary pattern; and
binarising the filtered fully-interconnected pattern.

5. The method of claim 4, wherein the applying and converting method steps are repeated multiple times.

6. The method of claim 3, wherein modifying the binary noise pattern into the fully interconnected binary pattern further comprises:
a) generating a list of blank regions in the binary noise pattern, wherein each blank region includes a group of connected blank pixels and no two blank regions are connected to each other;
b) determining if any of the blank regions include a span of blank pixels greater than 10% of the width of the binary noise pattern;
c) upon a positive determination, identifying the longest span in the selected blank region and determining a midpoint of the longest span;
d) inserting filled pixels around the determined midpoint to join two neighbouring filled regions; and
e) repeating steps b-d until no blank regions exist that include a span of pixels greater than 10% of the width of the binary noise pattern.

7. The method of claim 3, wherein generating a noise pattern comprises generating a Gaussian noise pattern of a predetermined size.

8. The method of claim 1, wherein the first substrate is a transfer belt.

9. The method of claim 1, wherein the second substrate is a platen on an XYZ translation stage or an existing printed object formed in previous printing operations.

10. A calibration marker formed by depositing toner material as a layer on a substrate of a three-dimensional printer, said calibration marker comprising:
deposited toner material forming a pattern having fully interconnected features that enable structural integrity of the calibration marker to be maintained during removal of the calibration marker from the substrate, the calibration marker has spectral energy concentrated substantially annularly at a predetermined radius from an origin in a frequency domain representation of the calibration marker.

11. A non-transitory recording medium comprising a two-dimensional calibration marker of pixel values recorded thereon, the calibration marker comprising a plurality of fully interconnected features of a predetermined size, and having an annular spectral energy spectrum concentrated at a radius determined by the predetermined feature size.

12. A system for calibrating a three-dimensional printer, the system comprising:
a memory for storing data and a computer program;
a processor coupled to said memory for executing said computer program, the computer program comprising instructions for:
generating an image of a calibration marker, the calibration marker having a pattern including fully interconnected features and having annular spectral energy concentrated at a radius determined by a size of the fully interconnected features;
transmitting the image of the calibration marker to the three-dimensional printer for forming the calibration marker;
receiving an image of the formed calibration marker from the three-dimensional printer;
comparing the image of the formed calibration marker with the image of the calibration marker to determine a distortion model representing the distortion introduced to the calibration marker during formation of the calibration marker;
slicing a three-dimensional model into a plurality of image slices; and
applying the distortion model to each of the image slices.

13. The system of claim 12, wherein the computer program further comprises instructions for generating the image of the calibration marker.

14. The system of claim 13, wherein the computer program further comprises instructions for:
generating a noise pattern;
applying a ring-shaped band pass filter to the generated noise pattern;
converting the noise pattern into a binary noise pattern having blank pixels and filled pixels;
modifying the binary noise pattern into a fully interconnected binary pattern by converting at least some of the blank pixels into filled pixels.

15. The system of claim 14, wherein the computer program further comprises instructions for:
applying the ring-shaped band pass filter to the fully interconnected binary pattern; and
binarising the filtered fully interconnected pattern.

16. The system of claim 15, wherein the computer program comprises instructions for repeating the applying and converting steps multiple times.

17. The system of claim 14, wherein the computer program further comprises instructions for:
a) generating a list of blank regions in the binary noise pattern, wherein each blank region includes a group of connected blank pixels and no two blank regions are connected to each other;
b) determining if any of the blank regions include a span of blank pixels greater than 10% of the width of the binary noise pattern;
c) upon a positive determination, identifying the longest span in the selected blank region and determining a midpoint of the longest span;
d) inserting filled pixels around the determined midpoint to join two neighbouring filled regions; and
e) repeating steps b-d until no blank regions exist that include a span of pixels greater than 10% of the width of the binary noise pattern.

18. The system of claim 14, wherein the noise pattern is a Gaussian noise pattern of a predetermined size.

19. A computer readable storage medium having a computer program recorded thereon for calibrating a three-dimensional printer, the program comprising:
code for generating an image of a calibration marker, the calibration marker having a pattern including fully interconnected features and having annular spectral energy concentrated at a radius determined by a size of the fully interconnected features;
code for transmitting the image of the calibration marker to the three-dimensional printer for forming the calibration marker;
code for receiving an image of the formed calibration marker from the three-dimensional printer;
code for comparing the image of the formed calibration marker with the image of the calibration marker to determine a distortion model representing the distortion introduced to the calibration marker during formation of the calibration marker;
code for slicing a three-dimensional model into a plurality of image slices; and
code for applying the distortion model to each of the image slices.

20. A system for calibrating a three-dimensional printer, said system comprising:
a controller configured to receive an image of a calibration marker;
an image generation unit configured to form a calibration marker based on the image of the calibration marker by depositing toner material on a first substrate, the formed calibration marker having a pattern including fully interconnected features, and having annular spectral energy concentrated at a radius determined by a size of the fully interconnected features;
a transfer unit configured to transfer the formed calibration marker from the first substrate to a second substrate without tearing;
a sensor configured to capture an image of the formed calibration marker; and
a computing system configured to compare the image of the formed calibration marker with the image of the calibration marker to determine a distortion model representing the distortion introduced to the calibration marker during formation and transfer of the calibration marker.

21. The system of claim 20, wherein the first substrate is a transfer belt and the second substrate is one of a platen on an XYZ translation stage, or an existing printed object formed in a previous printing operation.
